(19) United States
(12) Patent Application Publication
(10) Pub. No.: US 2010/0250123 A1
(43) Pub. Date: Sep. 30, 2010

(54) Method and system for dispensing material from machines

(75) Inventor: Scott A. Leman, Eureka, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/414,258

(22) Filed: Mar. 30, 2009

(51) Int. Cl. G01C 21/32; B60P 1/00; B65D 88/54

(52) U.S. Cl. 701/208; 414/812; 222/251

(57) ABSTRACT

A system and method dispenses material from a hauling and dispensing machine about a worksite such as a landscape or terrain development. The system uses positioning technologies that transmit positioning signals to the machine. An onboard controller can receive the positioning signals and determine the machine's actual position with respect to the worksite. The actual position can be compared to a desired topography for the worksite and any variation can be determined. From the determined variation, instructions can be generated to dispense and/or cease dispensing material. In one aspect, a remote management system can be included that generates the instructions and that manages a plurality of machines about the worksite.

### TECHNICAL FIELD

The present disclosure relates generally to methods and systems for preparing a worksite by the dispensing of materials about the worksite, and more particularly to managing and controlling the dispensing of materials from one or more mobile machines to produce a desired topography or terrain.

### BACKGROUND

There are many instances in which it is desirable to change the geography or topology of land or terrain to a desired contour or shape. Examples include the construction of airport runways, golf courses, highways and residential community developments. To shape large areas of terrain, large earth moving machines are often employed that can doze, grade, haul and dig the earth materials about the worksite. The movement and actions of the machines are usually organized and managed so that a determined amount of earthen material, such as soil, rock gravel or asphalt, is moved to the desired location about the worksite. Through the coordinated movement and actions of the machines, the desired or predetermined topography can be arrived at. Over the years, various systems have been developed that monitor the conditions of the worksite and track the location and position of the various machines about the worksite. The systems can utilize this information along with computer-based maps and communications networks to manage the machines and facilitate the development and preparation of the worksite.

For example, U.S. Pat. No. 5,850,341 discloses a method for managing various mobile machines that remove material from a worksite such as a mine. The machines can include equipment that transmits their instantaneous position about the worksite and the amount of material they are removing from the worksite. This information can be used to generate an actual model of the worksite in real time and can dynamically update the generated model to reflect changes and alterations to the worksite. Moreover, the actual worksite model can be compared with computer models reflecting the desired worksite topography to develop an ongoing work plan for developing the worksite. The positioning equipment can utilize the global positioning satellite network, laser transponders or RF networks.

U.S. Patent Publication No. 2007/0239338 A1 discloses a method for managing one or more compactor machines that compact or compress down earthen material about a worksite. The method can measure or sense the compaction response of the earthen material being compacted by the machine and determine the position of the compactor machine within the worksite using, for example, GPS and/or laser positioning signals. Based on this information, the method can generate a machine traffic plan directing various other machines such as hauling trucks and water trucks about the worksite to further the development of the site.

U.S. Patent Publication No. 2008/0208415 A1 discloses a method of managing the excavation of material from a worksite such as a mine. A plurality of machines may include equipment such as, again, GPS, for determining their positions about the worksite and may transmit that information to a central system. The method can make use of geographical models of the worksite and information about the machines to determine a work plan in which machines are allocated to their optimal jobs based on desired performance.

Even in view of the foregoing developments, there are still numerous ways in which position-determining technologies and communications networks can be configured and utilized to improve the management of machines and their operational activities in developing and shaping a worksite.

### SUMMARY

The disclosure describes, in one aspect, a method of managing the dispensing of material at a worksite from a material hauling and dispensing machine. The method includes receiving a positioning signal transmitted from a positioning transmitter with a receiver on the machine. Based in part on the positioning signal, an actual topography of the worksite is determined. The method compares the actual topography and a desired topography for the worksite. Material is then dispensed from the machine in response to the step of comparing the actual topography and the desired topography in order to deposit material about the worksite.

The disclosure describes, in another aspect, a method of managing the dispensing of material from a plurality of material hauling and dispensing machines about a worksite. The method includes storing a desired topography for the worksite in a management system. Machine transmitters on each of the plurality of the machines transmit position signals indicative of an actual topography the worksite to a system receiver. The management system compares the actual topography and the desired topography to determine variance between the actual topography and the desired topography. The management system then transmits an instruction signal from a system transmitter to a machine receiver on a machine which instructs the machine to dispense material in order to deposit material about the worksite.

In another aspect, the disclosure describes a system for managing the dispensing of material from a material hauling and dispensing machine about a worksite. The system includes a receiver on the machine for receiving a positioning signal from at least one positioning transmitter. The system also includes an onboard controller adapted to determine an actual elevation of the worksite based in part on the positioning signal. The system further includes a material dispensing device for dispensing material from the machine. The dispensing of material is controlled at least in part in response to the determined actual elevation.

### BRIEF DESCRIPTION OF THE DRAWINGS

FIG. 1 is a schematic diagram representing a three-dimensional worksite with a plurality of machines operating about the worksite and a satellite or laser implemented positioning system.

FIG. 2 is a diagrammatical side plan view of an articulated truck for hauling and dumping material adapted with a tilting dump body for dispensing material at a worksite, communications equipment, position determining equipment, and an onboard control system.

FIG. 3 is a diagrammatical side plan view of another embodiment of an articulated truck for hauling and dispensing material equipped with an ejector blade for ejecting material from a hauling body.

FIG. 4 is a diagrammatical side plan view of a wheel tractor scraper equipped with a bowl for scraping and hauling material and an elevator for dispensing the material at a worksite.

FIG. 5 is a flow chart illustrating an exemplary method of managing the dispensing of material from a plurality of machines about the worksite.

FIG. 6 is a flow chart illustrating an exemplary method of managing the dispensing of material through the onboard controller on the machine.

### DETAILED DESCRIPTION

This disclosure generally relates to the control and management of dispensing earthen materials from a mobile machine about a worksite. While the term “machine” may refer to any machine that performs some type of earth moving or construction operation, in the preferred embodiments the machines are hauling and dispensing machines such as articulated trucks, wheel tractor scrapers, dump trucks, and the like. These hauling and dispensing machines are typically characterized in that they can haul or transport materials to and about the worksite and can dispense or dump the materials at selected locations about the worksite. Because of the ability to readily hold and carry material, hauling and dispensing machines are able to transport and deliver materials from locations away from the worksite, such as quarries or mines, and thereby bring relatively foreign materials to the worksite. The materials referred to herein may include any suitable materials for use in preparing worksites such as soil, rock, sand, gravel, asphalt, landfill trash, ore, and the like.

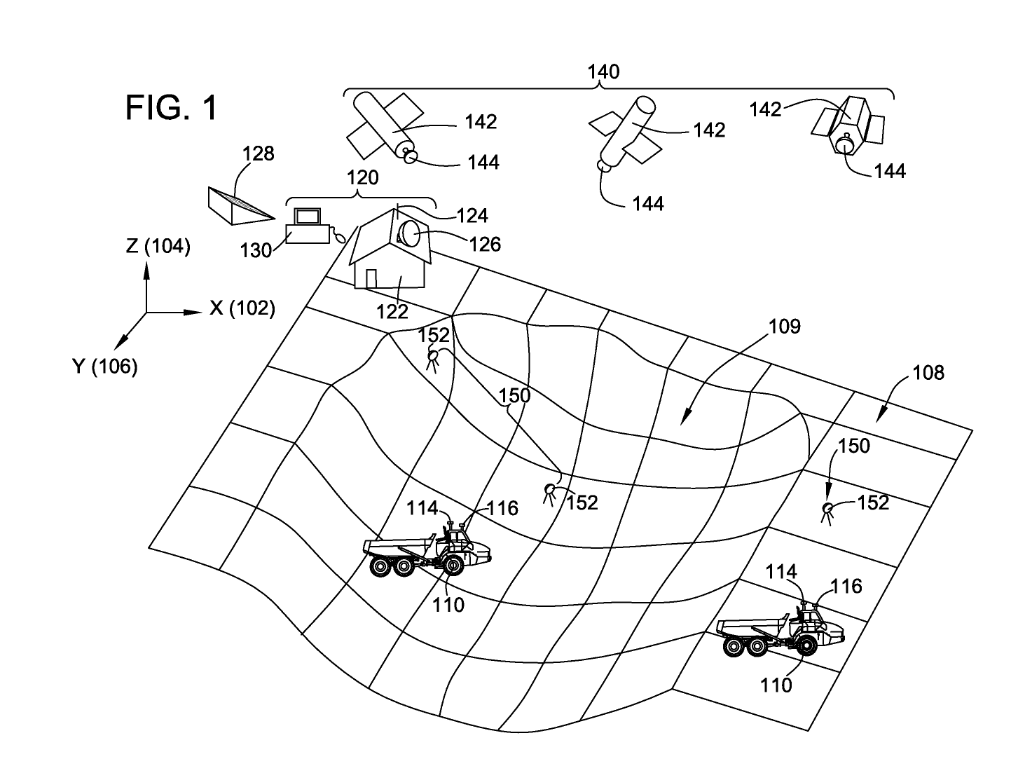

Referring to FIG. 1, there is illustrated an exemplary worksite 100 having a three dimensional topography as indicated by the X, Y, Z coordinates that may represent latitude 106, longitude 102, and elevation 104. The worksite 100 may have varying elevations, such as an elevation corresponding to an upper planar surface 108 and a different elevation corresponding to a depression or pit 109. In fact, the pit 109 can have many different elevations at different locations within the pit. Located on and moving about the worksite 100 may be a plurality of hauling and dispensing machines 110. As indicated, the machines 110 may be located at different elevations 104 about the worksite and may change elevation as they travel about the worksite. Each hauling and dispensing machine may be equipped with communications equipment such as a machine transmitter 114 and a machine receiver 116 located on an exposed location of the machine. Although illustrated as separate devices, in other embodiments the machine transmitter 114 and the machine receiver 116 can be combined as a single device.

To coordinate the actions of the different machines 110, a computer or electronically implemented management system 120 may be operated out of a fixed location on the worksite such as an immobile work station 122. The management system 120 can be a computer implemented application that is run on one or more computers 130 located at the work station 122. The computers 130 implementing the management system 120 may include a microprocessor, memory, a visual display monitor, and input-output mechanisms to operate and interact with personal at the worksite. In other embodiments, however, the management system 120 is not required to be based out of a fixed location and may be sustained through interaction of electronic devices on various mobile units. To communicate with the plurality of machines 110, the management system 120 may include a system transmitter 124 and a system receiver 126, possibly located at appropriate locations on the work station 122 to maximize their exposure to the worksite 100. As with the communications equipment on the machines, the system transmitter 124 and system receiver 126 may be separate devices or can be combined into a single unit. The communications network established between the machines 110 and the management system 120 can be a wireless network utilizing radio frequencies, cellular networks, blue tooth or other suitable technologies.

In order for the hauling and dispensing machines 110 to determine their positions about the worksite 100, a positioning system employing one or more positioning transmitters that generate positioning signals interpretable by the machines can be included. In the illustrated embodiment, the positioning system can be realized as a global positioning satellite system, or GPS system 140, as is familiar to those of skill in the art. In the GPS system 140, a plurality of man-made satellites 142 orbit about the earth in fixed or precise trajectories. Each satellite 142 includes a positioning transmitter 144 that transmit positioning signals encoding time and positioning information towards earth. By calculating, such as by triangulation, between the positioning signals received from different satellites, one can determine their instantaneous location on earth. In the present embodiment, the machine receivers 116 can be configured to also receive the positioning signals from the positioning transmitters 144 but in other embodiments, a specific and dedicated GPS receiver may be included on the machines 110.

Instead of or in addition to the GPS system 140, a laser-based system 150 may be employed to generate and transmit the positioning signals that are received by the machines 110. In a laser based system 150, one or more laser transmitters 154 that may be shaped as elongated tri-pod like structures are placed about the worksite 100, including at different elevations. For example, laser transmitters 154 may be located at and project from the upper planar surface 108 and from various elevations within the pit 109. To transmit positioning signals, the laser transmitters 154 can transmit laser light in a 360° degree revolution from the laser transmitter that provides a plan of laser light generally parallel to a fixed reference point, such as the upper planar surface 108. The laser light may be received by the machine receiver 116 or by a separate optical receiver on the machine. If the precise location of the laser transmitters 154 is known, it can be appreciated that the actual position of the machine 110 including its elevation within the worksite 100 can be determined. Such determination can be conducted based upon, as examples, Doppler effect of the laser light or time periods between laser incidents on machine receivers.

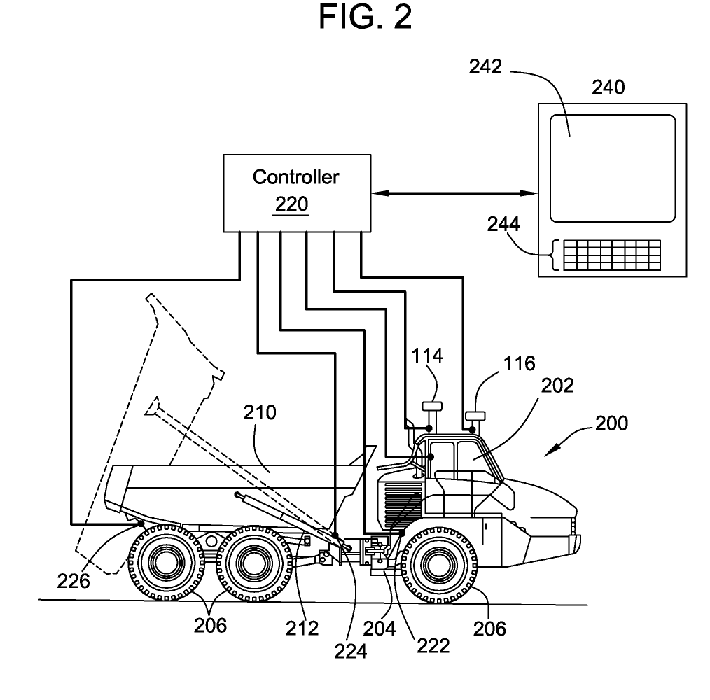

Referring to FIG. 2, there is illustrated in more detail a hauling and dispensing machine in the particular form of an articulated truck 200. In addition to the machine transmitter 114 and machine receiver 116, the articulated truck 200 has various physical and structural components for functioning as a hauling and dispensing machine. These include a forwardly located operator cab 202 that is mounted on a frame 204 of the articulated truck 200. The frame 204 in turn is supported on a plurality of wheels 206 that contact and propel the articulated truck with respect to the ground. In the illustrated embodiment, the machine transmitter 114 and the machine receiver 116 can be located on and project from the roof of the operator cab 202 but in other embodiments can be located at other locations on the machine.

For holding the material, there is located toward the rear of the articulated truck 200 an articulating dump-body 210. The dump-body 210 is a walled structure that defines a volume in which the material is contained during hauling. To load material into the dump-body 210, a loader or an excavator as are known in the art can be used. To dispense the material, the dump-body 210 can be tilted rearwardly with respect to the frame 204 from a horizontal position to an articulated position, indicated in dashed lines, by suitable hydraulic cylinders 212 or the like. As can be appreciated from the illustrated dotted lines, when the dump-body 210 is tilted material in the dump-body will dispense from the rear of the articulated truck 200. Dispensing generally refers to the ejection or dumping from the machine of the material that is being transported about the worksite in order to add material to a particular location at the worksite. Furthermore, the degree or angle at which the dump-body 210 is tilted or articulated with respect to the frame 204 can be adjustably regulated to adjust the dispensing rate of the material from the articulated truck 200. It will be appreciated that in other embodiments, instead of or in addition to an articulating dump-body, the dispensing mechanism may be an ejector mechanism, a material conveyor ejecting material from the machine or an adjustable trap door through which material may fall.

To direct the operation of the articulated truck 200 and coordinate communication with the management system and positioning transmitters, the articulated truck can include an onboard controller 220 such as an electronic control module that includes a microprocessor or other appropriate circuitry and can include memory or other appropriate data storage. While the controller 220 illustrated in FIG. 2 is represented as a single unit, in other embodiments the controller may be distributed among a plurality of distinct and separated units. Additionally, the controller may be a computer such as a laptop or notebook computer that is taken into the operator cab 202 and coupled through an appropriate interface. To enable communication with the management system and the positioning transmitters, the controller 220 may be communicatively linked with the machine transmitter 114 and the machine receiver 116 by any appropriate means.

Additionally, the controller 220 may communicate with various other sensors and controls on the articulated truck 200. For example, the controller 220 may linked with a machine velocity sensor 222 coupled to the engine or drive shaft to monitor or measure the speed or velocity of the articulated truck with respect to the ground. The controller 220 may also be communicatively connected to a dump-body sensor and control 224. The dump-body sensor and control 224 works in conjunction with the hydraulic cylinders 212 to control and adjust the tilt angle of the dump-body 210 with respect to the frame 204. Additionally, the dump-body sensor and control 224 may measure the tilt angle of the dump-body 210 and convey this information back to the controller 220. To determine the material dispensing rate at which material is dispensed or ejected from the articulated truck 200, a dispensing rate sensor 226 such as a fly-wheel may be included at the rear of the dump-body 210 and linked to the controller 220. In another embodiment, the dispensing rate sensor 226 can measure the weight and the change in weight of the contents of the dump-body 210 and, using an appropriate algorithm, determine the material dispensing rate. In various embodiments, the onboard controller 220 itself may be able to adjust or manipulate some of these features (.e. velocity, dump-body tilt angle,) through the sensors or controls.

The controller 220 may also communicate with a display device 240 located in the operator cab 202. The display device 240, depicted schematically in FIG. 2, can be a liquid crystal type device with a screen 242 that generates visual and graphical images for conveying information to the operator. For example, the screen may display a visual map of the worksite and, in conjunction with the positioning signals from the positioning transmitters may indicate to the operator the machine's position within the worksite. Moreover, the display device 240 may include one or more buttons, dials, or switches 244 that enables the operator to interface with the controller 220, thereby functioning as the user interface with the onboard controller 220 and the articulated truck 200. In addition to depicting visual images, the display device 240 may include speakers and microphones that enable audio interaction as well.

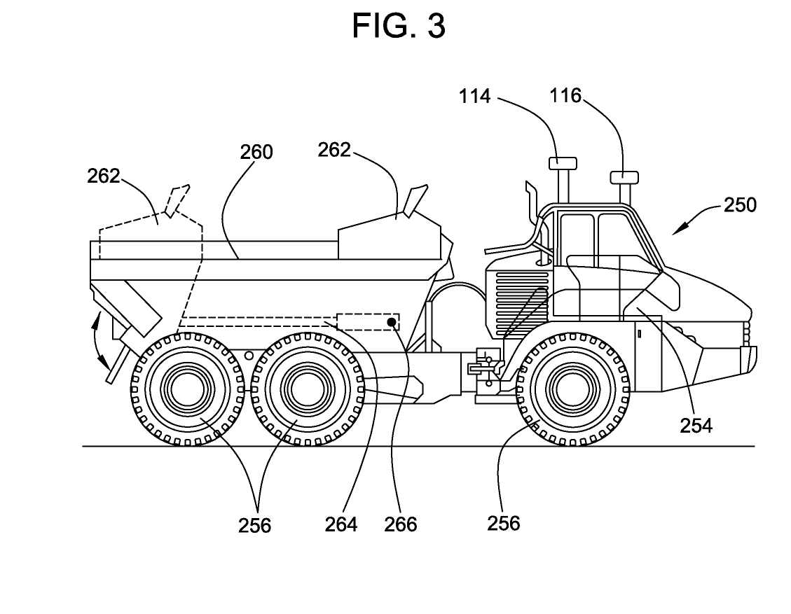

Referring to FIG. 3, there is illustrated another embodiment of an articulated truck 250 which is configured with an ejector mechanism to dispense material. Like the articulated truck shown in FIG. 2, the present embodiment of the articulated truck 250 has a forwardly located operator's cab 252 and rearwardly located material hauling body 260 that are supported on a plurality of wheels 256. Instead of tilting the body to dispense material, the present embodiment of the articulated truck has an ejector mechanism including an ejector blade 262 that is adapted to travel longitudinally within the space defined by the hauling body 260. In FIG. 3, the ejector blade 262 is illustrated in both its foremost and rearmost disposed travel positions. As can be appreciated, forcing the ejector blade 262 to travel rearwardly in the hauling body 260 forcibly ejects or pushes the material from the rear of the articulated truck. One possible advantage of ejecting material with a traveling ejector blade, as opposed to tilting a dump-body, is that the articulated truck can dispense material at location with low overhead clearances.

To cause the ejector blade 262 to travel within the hauling body 260, a hydraulically actuated, telescoping piston 264 can be included in the hauling body as indicated in dashed lines. Although not shown, the ejecting articulated truck 250 can be equipped with an onboard controller and various sensors as discussed above. Included among these can be a blade sensor and control 266 that monitors and controls the travel of the ejector blade 262 in order to determine the rate and/or amount of material being ejected from the rear of the articulated truck 250. To communicate with the management system and the positioning transmitters at the worksite the ejector configured articulated truck 250 can include a machine transmitter 114 and a machine receiver 116.

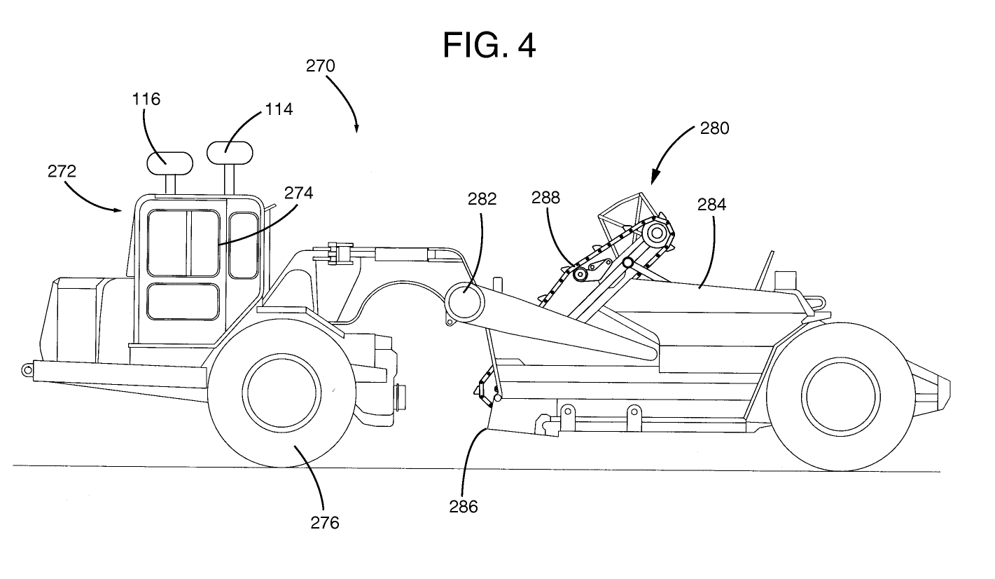

Referring to FIG. 4, instead of an articulating truck, the hauling and dispensing machine can be wheel tractor scraper 270 for removing and adding material from and to the worksite. The wheel tractor scraper 270 has a forward tractor portion 272 including an operator's cab 274 supported on wheels 276. A rearward scraper portion 280 is coupled to the forward tractor portion 272 by an articulated joint 282. The scraper portion 280 includes a bowl 284 for collecting and hauling material. During operation, the bowl 284 is lowered to engage the ground with a cutting edge 286 and is pulled forwardly by the tractor portion 272 so that cutting edge scraps or cleaves material into the bowl. To assist in loading and unloading material to the bowl 284, the scraper portion 280 may further include earth moving equipment 288 such as an elevator, a conveyor or an auger. The wheel tractor scraper 270 can transport the material to and about the worksite, whereat the earth moving equipment 270 can dispense the material at desired locations. To facilitate the managed dispensing of material, the wheel tractor scraper can include a machine transmitter 114, a machine receiver 116, and an onboard controller as described above with respect to the articulated trucks.

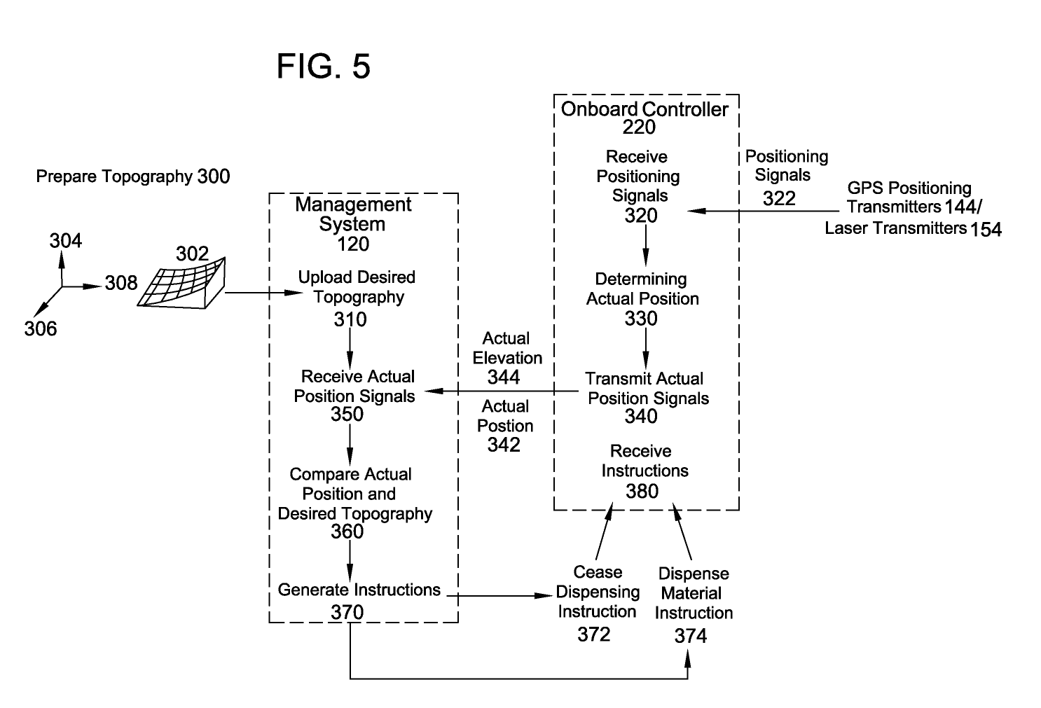

Referring next to FIG. 5, there is illustrated, as an example, a flow chart according to which the management system 120, the onboard controller 220, and the positioning system may interact to coordinate and manage the dispensing of material from the hauling and dumping machines. As an initial matter, through a preparing step 300 a desired terrain or topography 302 for the worksite that reflects the desired or finished shape or contour of the worksite is developed. The desired worksite topography 302 may be generated using a computer and appropriate software and may be in the form of a computer readable and storable three-dimensional electronic model. The desired worksite topography 302 may include a plurality of desired worksite elevations 304, each at the intersection of a given latitude 306 and longitude 308. The resolution of the desired worksite topography 302 may vary from inches or centimeters to yards or meters depending upon the accuracy necessary in preparing the worksite. In an uploading step 310, the desired worksite topography 302 is uploaded or stored to the management system 120.

Simultaneously or independently, the onboard controller 220 on the machine may conduct an additional series of steps through which the onboard controller determines the actual position of the machine about the actual worksite. To accomplish this, the onboard controller 220 in a machine-receiving step 320 may receive positioning signals 322 from, for example, either the GPS positioning transmitters 144 or laser transmitters 154 via the machine receiver. Utilizing these positioning signals 322, the onboard controller 220 may in a machine-determining step 330 determine its own and thus the machine's actual position relative to the transmitters. As can be appreciated, when the actual position of the machine has been determined, and the size and shape of the machine relative to the worksite are known, the actual topography and contour of the worksite can be determined. For example, a correlation factor or factors based on the height or size of the machine can be ascertained which enables conversion of the actual position of the machine to the actual topography of the worksite. Conversion between machine position and the actual topography can be performed by either the onboard controller or the management system. In the illustrated embodiment, during the machine-determining step 330, the vertical position or actual elevation 344 is determined, i.e., the position of the machine along the Z-axis of the worksite from which the actual topography of the worksite is calculated. The actual elevation 344 can be determined with respect to some fixed reference point such as sea level. In a subsequent or ongoing machine-transmission step 340, the onboard controller 220 may transmit its actual position as position signals 342 via the machine transmitter onto the management system 120.

In a system-receiving step 350, the management system 120 by way of the system transmitter may receive the actual position signals 342 including the actual elevation 344. The position signals 342 represent the actual location of the machine and thus the actual topography of the worksite at the time the onboard controller 220 transmits them. In a comparison step 360, the management system 120 compares the received position signals 342 and the desired worksite topography 302 to determine the variance or difference between the two. As part of the comparison step, the variation between the actual elevation 344 of the actual worksite topography and the desired elevation 304 is calculated. The variance directly corresponds to how much additional material the machine should dispense at a particular location to raise the actual elevation 344 to be equal with the desired elevation 304.

After determining the variation or difference between actual position and desired worksite topography, the management system 120, in an instruction step 370, can generate appropriate instructions to direct and manage the machines via the onboard controllers about the worksite in order to arrive at the desired topography. Signals carrying the instructions can be transmitted from the system transmitter to the machine receivers. By way of example, if the actual elevation 344 and the desired elevation 304 are equal, meaning the variance is zero, the management system concludes that no further material needs to be dispensed at the actual position of the machine. The management system 120 generates and transmits a “cease dispensing” instruction 372 to the onboard controller 220 that the machine is to cease dispensing material. If, however, there is variation between actual elevation 344 and desired elevation 304, the management system 120 generates and transmits an “initiate or dispense material” instruction 374 to the onboard controller 220 that the machine is to continue or initiate dispensing of material at its actual location. These instructions may be received by the onboard controller 220 via the machine receiver in a receiving instructions step 380, in response to which the onboard controller may undertake the called-for actions, either automatically or by directing the operator accordingly via the onboard display.

As can be appreciated, as the machine dispenses material, the actual position of the machine at a given location will change, particularly by the actual elevation increasing. The onboard controller 220 back in the machine-receiving step 320 may continue to receive positioning signals 322 from the positioning transmitters even as the actual topography changes. The onboard controller 220 may continue to determine its position and, in the machine-transmission step 340, may continue to transmit updated position signals 342 to the management system 120. The management system 120 thereby dynamically accounts for the alterations to and development of the worksite and generates instructions back to the onboard controller 220 accordingly. Hence, as long as variation or difference exists between the actual position and desired topography, a closed-looped or feedback-correcting cycle occurs.

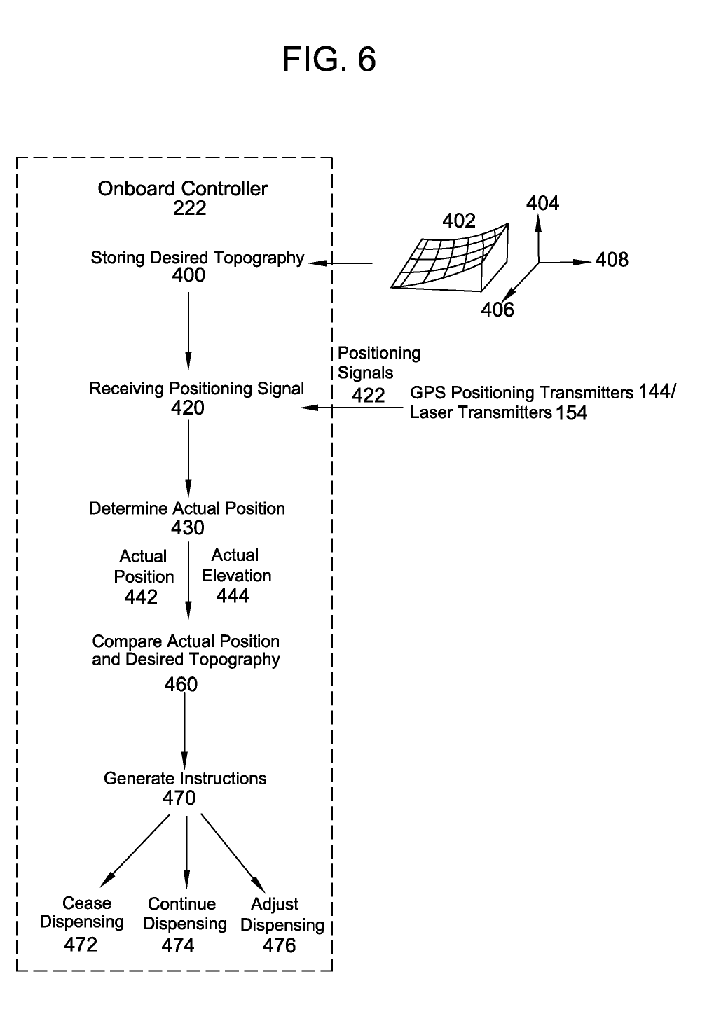

Referring to FIG. 6, there is illustrated as a flow chart another embodiment of a method in which the onboard controller 220 on the hauling and dispensing machine manages itself independently of the management system. In an initial uploading or storing step 400, a desired topography 402 is developed as a computer model and stored or uploaded into the onboard controller 220. The desired topography 402 can include predetermined values for the desired elevation 404 for given values of corresponding latitude 406 and longitude 408. As the machine moves about the actual worksite, the onboard controller 220, in a machine-receiving step 420, may receive positioning signals 422 from the various positioning transmitters such as the GPS positioning transmitters 144 or the laser transmitters 154. Using the positioning signals 422, which may be received via the machine receivers, the onboard controller 220 in a machine-determining step 430 may determine or calculate its actual position 442 including its actual elevation 444 within the worksite. Unlike the method illustrated in FIG. 3, the onboard controller 220 may itself perform a machine-comparison step 460 between the actual position of the machine and the desired topography 402. The machine-comparison step 460 will indicate the variance or difference, if any, between the actual elevation 444 and the desired elevation 404. Using conversion factors, the onboard controller can determine the actual topography and actual elevation of the worksite from the actual position of the machine.

From the results of the machine-comparison step 460, the onboard controller 220 may in an instruction generating step 470 direct or instruct the machine in order to further worksite development toward the desired topography. For example, if the variance between the actual elevation 444 and the desired elevation 404 is zero, the onboard controller 220 will interpret this result as indicating that no further material is necessary at the actual location. Thus, the onboard controller 220 may generate a “cease dispensing” instruction 472 that causes or commands the machine to cease dispensing material. If the results of the machine-comparison step 440 indicate a variance between actual elevation 444 and desired elevation 404, the onboard controller 220 concludes that more material is necessary at the current actual location of the machine. The onboard controller 220 may therefore generate an “initiate or continue dispensing” command 474 that causes the machine to dispense the material at its present actual location.

In a further embodiment, the onboard controller may adjust the dispensing rate, for example, to vary the thickness of the material being deposited on the ground at the worksite. For example, referring back to FIG. 2, the onboard controller 220 through the dispensing rate sensor 226 will know the rate at which material is being discharged from the machine and through the machine velocity sensor 222 will know the velocity of the machine. From these two parameters, and with knowledge of the density of the material, the onboard controller 220 can determine the resulting thickness of the material being applied to the worksite. The onboard controller 220 can adjust the thickness by increasing or decreasing the tilt angle of the dump body 210 or the velocity of the machine. To do so, as illustrated in FIG. 4, the onboard controller 220 can generate an “adjust dispensing rate” instruction 476 that is communicated to the appropriate sensors or controls on the machine. To provide closed looped or feedback correcting control that reflects the real time alteration and development of the worksite, the onboard controller 220 may continue to receive in machine-receiving step 420 the positioning signals 422 from the positioning transmitters and continually update and re-compare the actual position with the desired topography. In another embodiment, to determine the adjusted elevation, the onboard controller using the sensors provided on the machine may measure the past values for the dispensing rate, machine velocity, and previous positions of the machine and calculate the elevation increase over the effected area.

The methods of managing the hauling and dispensing machines at the worksite described with respect to FIGS. 5 and 6 are exemplary only and may be adapted by changing the order or number of steps or by interchanging steps between the described methods. Additionally, other functions and operations, in addition to those described herein, may be included within the practice of the disclosure.

### INDUSTRIAL APPLICABILITY

As explained above, the present disclosure is applicable to developing and shaping a worksite projected over an area of land or terrain in which the initial elevation of the land must be built up or changed. In an aspect, referring to FIG. 1, engineers, surveyors or the like in an initial step will develop a desired topography 128 which includes the desired contours and shape of the finished worksite, including the desired elevation values for the finished site. The desired topography may require substantial alteration to the existing contour of the present worksite. This desired topography 128, which may be generated as a three-dimensional computer model, is uploaded to a computer implemented management system that may be maintained on one or more servers at the worksite 100.

The management system 120 next collects information and data about the actual topography of the worksite 100. To collect real time information about the actual topography, the management system 120 may receive position information in the form of position signals from a plurality of work machines 110 moving about the worksite, including one or more hauling and dispensing machines that haul material to and about the worksite. Each machine may determine its own position by receiving positioning signals from a GPS based transmitter or laser transmitters placed at fixed locations about the worksite 100. An onboard controller determines the machine's actual position from these positioning signals and transmits the actual position, including actual elevation, possibly along with other information, to the management system. From the actual position and the actual elevation of the machine, the management system or, in other embodiments, the onboard controller can determine the actual topography and elevation of the worksite.

By continuously receiving actual position information from the plurality of machines 110 moving about the worksite as it is developed, the management system 120 can maintain an updated model of the actual topography, alterations to which may be reflected nearly instantaneously. By comparing actual topography with the predetermined desired topography 128, the management system can determine any variance between the actual elevation and the desired elevation. If such variance exists at a particular location, the management system transmits instructions to a hauling and dispensing machine at the location to dispense material. Other possible instructions may include adjusting the dispensing rate or, if no variance exists, to cease dispensing altogether. These instructions ordering that appropriate actions be taken may be presented to the machine operator via an onboard display or, in an automated environment, may be carried out automatically by the onboard controller.

If no machine is at that particular location, the management system by way of receiving and knowing the actual positions of other machines can instruct an appropriate machine to the location for dispensing material. The system may develop a worksite traffic plan by selectively directing hauling and dispensing machines about the worksite to areas where material needs to be dispensed. Accordingly, the management system can manage and coordinate in real time a plurality of loading and hauling machines about the worksite 100. The continued transmitting and sending of position signals and instructions creates a feedback or closed looped control system in which machines cease dispensing upon achievement of the desired topography.

In another aspect, the hauling and dumping machines may manage themselves independently of the management system. For example, the desired topography 128 may be directly uploaded to the onboard controller located on the machines 110. The onboard controller may continuously determine its actual position from the transmitted positioning signals and compare that information to the desired topography 128. If variance exists regarding elevation, the onboard controller may instruct the operator or, more directly, the machine to dispense material whereas if the variance is zero, the onboard controller may instruct the operator or machine to cease dispensing. Furthermore, through sensors, the onboard controller may sense the material dispensing rate and/or machine velocity and may adjust either variable to change the material thickness applied at the worksite. This “dump on the fly” feature reduces the need for subsequent worksite development with additional machines or labor.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A method of managing the dispensing of material at a worksite from a material hauling and dispensing machine, the method comprising:
receiving a positioning signal transmitted from a positioning transmitter with a receiver on the machine;
determining an actual topography of the worksite based in part on the positioning signal;
comparing the actual topography and a desired topography;
dispensing material from the machine in response to the step of comparing the actual topography and the desired topography in order to deposit material at the worksite.

2. The method of claim 1, wherein the actual topography includes an actual elevation of the worksite, and the desired topography includes a desired elevation.

3. The method of claim 1, wherein the step of dispensing material further comprises adjusting a material dispensing rate of the machine.

4. The method of claim 1, wherein the step of determining the actual topography includes determining an actual position of the machine from the positioning signals and calculating the actual topography of the worksite from the actual position and a correlation factor.

5. The method of claim 4, further comprising transmitting signals indicative of the actual position of the machine from a transmitter on the machine to a remote management system.

6. The method of claim 5, wherein the remote management system performs the steps of determining the actual topography of the machine and comparing the actual topography and the desired topography.

7. The method of claim 6, further comprising the step of transmitting an instruction signal from a system transmitter of the remote management system to a machine receiver on the machine, the instruction signal instructing the machine to adjust the material dispensing rate.

8. The method of claim 5, wherein the remote management system receives signals from a plurality of material hauling and dispensing machines, the signals indicative of the actual position of each of the machines.

9. The method of claim 1, wherein the steps of determining the actual topography of the machine and comparing the actual topography and the desired topography are performed by an onboard controller.

10. The method of claim 1, wherein the positioning transmitter is selected from a group comprising a global positioning satellite and an onsite laser transmitter.

11. The method of claim 3, wherein the step of adjusting the material dispensing rate includes adjusting a tilt angle of an articulating dump-body; adjusting velocity of the machine; or adjusting travel of an ejector blade.

12. The method of claim 1, further comprising the step of carrying material about the worksite with the material hauling and dispensing machine.

13. A method of managing the dispensing of material from a plurality of material hauling and dispensing machines at a worksite comprising:
storing a desired topography for the worksite in a management system;
transmitting position signals from machine transmitters on each of the plurality of the machines to a system receiver, the position signals indicative of an actual topography the worksite;
comparing the actual topography and the desired topography to determine variance between the actual topography and the desired topography;
transmitting an instruction signal from a system transmitter to a machine receiver on at least one machine, the instruction signal instructing the at least one machine to dispense material to deposit material at the worksite.

14. The method of claim 13, wherein the desired topography includes a desired elevation and the actual topography includes an actual elevation.

15. The method of claim 13, further comprising transmitting updated position signals from the machine transmitter of the at least one machine to the system receiver, the updated position signals indicative of an updated actual topography.

16. The method of claim 13, further comprising a step of generating the instruction signal with the management system in response to determined variance between the actual topography and the desired topography.

17. A system for managing the dispensing of material from a material hauling and dispensing machine at a worksite comprising:
a receiver on the machine for receiving a positioning signal from at least one positioning transmitter;
an onboard controller adapted to determine an actual elevation of the worksite based in part on the positioning signal; and
a material dispensing device for dispensing of the material from the machine, the dispensing of material controlled at least in part in response to the determined actual elevation.

18. The system of claim 17, wherein the onboard controller further includes memory for storing a desired topography including a desired elevation for the worksite.

19. The system of claim 17, wherein the onboard controller is adapted to compare the actual elevation and the desired elevation.

20. The system of claim 17, wherein the material dispensing device is selected from a group consisting of an articulating dump-body, a travelable ejector blade, a material conveyor, and an adjustable trap door.
